(19) United States
(12) Patent Application Publication
(10) Pub. No.: US 2012/0304078 A1
(43) Pub. Date: Nov. 29, 2012

(54) METHOD AND APPARATUS FOR JOINING A MEETING USING THE PRESENCE STATUS OF A CONTACT

(75) Inventors: Muralidharan Ramaswamy, Pleasanton, CA (US); Melville Cheryeth, San Jose, CA (US); Jinseok Nam, Sunnyvale, CA (US)

(73) Assignee: CISCO TECHNOLOGY, INC., San Jose, CA (US)

(21) Appl. No.: 13/117,683

(22) Filed: May 27, 2011

(51) Int. Cl. G06F 3/01; G06F 15/16

(52) U.S. Cl. 715/753

(57) ABSTRACT

In one embodiment, a method includes accessing a contact list displayed on a display screen, the contact list being arranged to display a contact associated with a user. The method also includes identifying the contact having an associated first presence status indicator, and activating the first presence status indicator. The first presence status indicator indicates a participation of the contact in a meeting, and is presented on the display screen. Activating the first presence status indicator causes information arranged to enable a user to join the meeting to be presented on the display screen.

### TECHNICAL FIELD

The disclosure relates generally to collaborative communications and teleconferencing software. More specifically, to enabling a party to join a meeting using a presence status indicator of a contact which indicates that the contact is participating in the meeting.

### BACKGROUND

Teleconferencing applications enable parties in different locations to participate in a common, virtual meeting. A host of a virtual meeting supported by a teleconferencing application generally issues invitations to parties that the host would like to have participate in the virtual meeting. Such invitations are typically issued through email, and contain information that allows recipients to join the meeting at a designated time, e.g., the time at which the meeting is scheduled to begin. The information provided in an email that invites a recipient to join a meeting generally also includes information that enables the meeting to be added to a calendar of the recipient.

A party that has not been invited to a meeting may learn about the meeting, and may decide that the meeting is in an area of interest. Hence, such a party may wish to join the meeting. In order for a party to join a meeting to which he or she has not been invited, the party generally searches for the name of a host, contacts the host to request an invitation to the meeting, and awaits a response from the host. The tasks of identifying a meeting host, requesting an invitation to a meeting, and obtaining the invitation to the meeting may be time consuming. Thus, an uninvited party may not readily gain an invitation to participate in a meeting.

### BRIEF DESCRIPTION OF THE DRAWINGS

The disclosure will be readily understood by the following detailed description in conjunction with the accompanying drawings in which:

FIG. 1 is a block diagram representation of an overall system that supports a contact list in which a presence status indicator of a contact may be used, e.g., substantially activated, to allow a user to join a meeting in accordance with an embodiment.

FIG. 2 is a process flow diagram which illustrates a first method of joining a meeting through using a presence status indicator of a contact in a contact list in accordance with an embodiment.

FIGS. 3A-C are a process flow diagram which illustrates a second method of joining a meeting through using a presence status indicator of a contact in a contact list in accordance with an embodiment.

FIG. 4 is a process flow diagram which illustrates a method of allowing a user to join a meeting through using a presence status indicator of a contact in a contact list in accordance with an embodiment.

FIG. 5 is a block diagram representation of a user system, a conference server, and an application server of an overall system that supports a contact list in which a presence status indicator of a contact may be used to allow a user to join a meeting in accordance with an embodiment.

FIG. 6A is a diagrammatic representation of a display that exhibits a contact list which includes a contact with a presence status indicator that indicates that the contact is participating in a meeting at a time t1 in accordance with an embodiment.

FIG. 6B is a diagrammatic representation of a display, e.g., display 636 of FIG. 6A, at a time t2 when a presence status indicator, e.g., presence status indicator 620 of FIG. 6A, is substantially activated to obtain meeting information in accordance with an embodiment.

FIG. 6C is a diagrammatic representation of a display, e.g., display 636 of FIG. 6A, at a time t3 after a user has joined a meeting using a presence status indicator, e.g., presence status indicator 620 of FIG. 6A, in accordance with an embodiment.

FIG. 6D is a diagrammatic representation of a calendar displayed on a display, e.g., display 636 of FIG. 6A, at a time t4 after a user has joined a meeting using a presence status indicator, e.g., presence status indicator 620 of FIG. 6A, in accordance with an embodiment.

### DESCRIPTION OF EXAMPLE EMBODIMENTS

### General Overview

According to one aspect, a method includes accessing a contact list displayed on a display screen, the contact list being arranged to display a contact associated with a user. The method also includes identifying the contact having an associated first presence status indicator, and activating the first presence status indicator. The first presence status indicator indicates a participation of the contact in a meeting, and is presented on the display screen. Activating the first presence status indicator causes information arranged to enable a user to join the meeting to be presented on the display screen.

### DESCRIPTION

Often, a party may discover the existence of a meeting, e.g., a virtual meeting such as a teleconference, on a topic that is of interest to the party. Thus, the party may wish to join such a meeting. Typically, in order for the party to join a meeting to which the party has not been invited, the party may need to identify the host or owner of the meeting, and contact the host or owner to solicit an invitation to the meeting. Thus, the process of gaining an invitation to an established or previously scheduled meeting may be time consuming.

Many teleconferencing applications, collaborative communications applications, and enterprise unified applications or platforms have associated contact lists which identify contacts of a user of the applications. The contact lists are generally configured to provide the names of contacts, as well as presence status or availability indications of the contacts. If a contact is available, a contact list may provide a presence status indication that the contact is “available.” If a contact is busy, a contact list may provide a presence status indication that the contact is “busy.” In one embodiment, when the contact is busy, an additional indication may be provided to indicate what the contact is actually doing. For example, when a contact is participating in a meeting, a contact list may provide a presence status indication that the contact is “in a meeting.”

By allowing a party to join a meeting by clicking on, e.g., using a mouse or a track pad of a computing system, or otherwise selecting a presence status indication of a contact that is participating in the meeting, the addition of the party as a participant in the meeting may be substantially facilitated. A user or party may efficiently join, or at least initiate a process of joining, an on-going meeting by clicking on a presence status indication or an availability status indication associated with a contact list to substantially activate the presence status indication or the availability status indication. That is, a passive presence status indication may be substantially activated to enable a user to join or initiate joining a meeting in progress using the presence status indication as an interface. As a result, a user may effectively facilitate joining a meeting using a few clicks, e.g., of a mouse or a track pad, rather than sending a request, e.g., through e-mail, to an appropriate party and awaiting a reply from the party that includes meeting information that enables the user to join the meeting.

In one embodiment, an application that maintains a contact list may be arranged to store information relating to a meeting that a contact is participating in. When a user clicks on or otherwise selects a presence status indication of a contact in a contact list that indicates that the contact is participating in a meeting, the information relating to the meeting may be provided, e.g., displayed, to the user to enable the user to join the meeting. In addition to providing meeting information to the user, the user may be provided with an active link or button that enables the user to join the meeting. It should be appreciated, however, that in another embodiment, clicking on or otherwise selecting a presence status indication of a contact in a contact list that indicates that the contact is participating in a meeting may automatically enroll a user in the meeting using the stored information relating to the meeting, substantially without otherwise providing the stored information to the user.

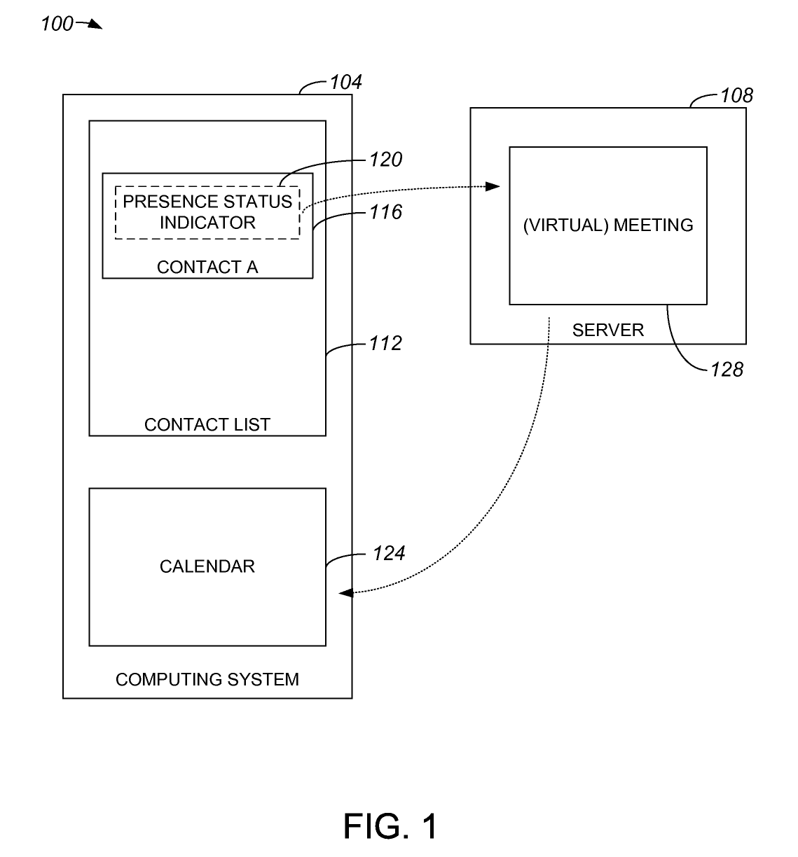

Referring initially to FIG. 1, an overall system that supports a contact list in which a presence status indicator of a contact that indicates participation in a meeting may be used, e.g., substantially activated, to allow a user to join the meeting will be described in accordance with an embodiment. An overall system 100, which may be implemented within a communications network includes a computing system 104, e.g., a computing system that is used by a user, and a server 108 that supports a meeting 128, e.g., a virtual meeting. Computing system 104 supports a contact list 112 that includes at least one contact 116. Contact 116 is generally a party or individual that a user of computing system 104 substantially tracks, e.g., by monitoring whether contact 116 is available or busy.

Contact 116 has an associated presence status indicator 120 that indicates the presence status of contact 116. In the described embodiment, presence status indicator 120 includes text that indicates that contact 116 is participating in meeting 128. Presence status indicator 120 is generally in a passive, or inactive, state until a user activates presence status indicator 120 by clicking on, or otherwise selecting, presence status indicator 120. Presence status indicator 120 may change and indicate when contact 116 is in meeting 128, upon contact 116 joining the meeting 128. In one embodiment, such a status change may occur substantially automatically at a scheduled time when contact 116 is to join meeting 128, and at the approximate moment when contact 116 logs into meeting 128, presence status indicator 120 effectively becomes substantially activatable. As such, the user may click on presence status indicator 120 to effectively request to join meeting 128. When the user activates presence status indicator 120, the user may join meeting 128. Once the user joins meeting 128, a calendar 124 associated with the user may be updated to indicate that the user is participating in meeting 128.

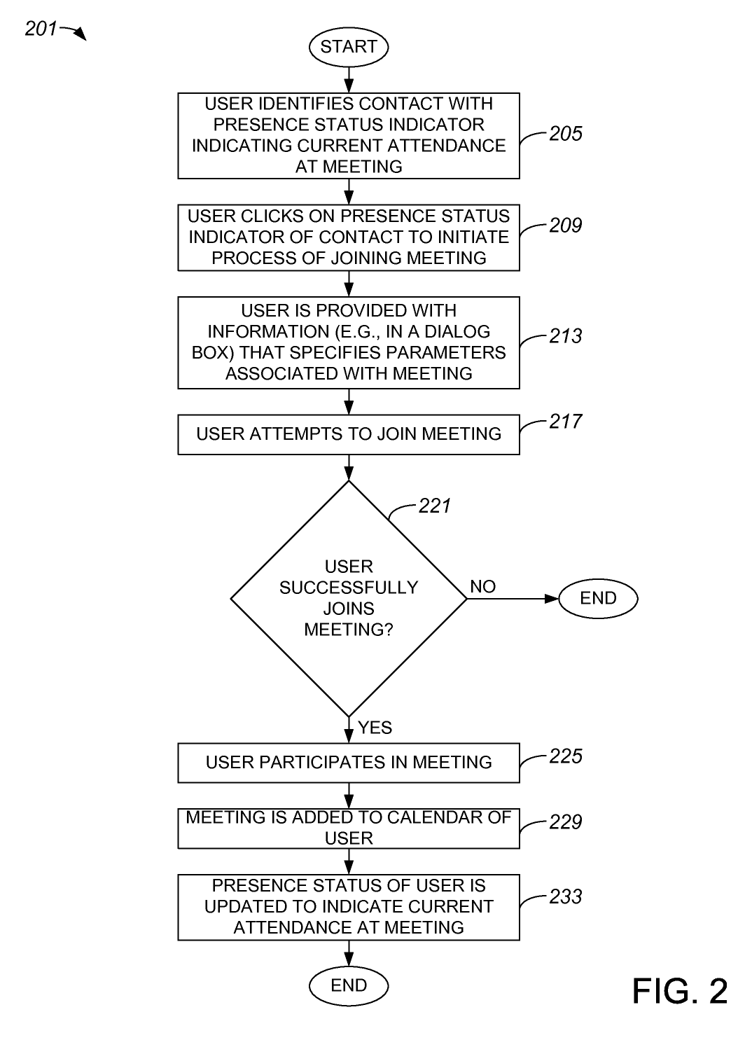

FIG. 2 is a process flow diagram which illustrates one method of joining a meeting through using a presence status indicator of a contact in a contact list in accordance with an embodiment. A process 201 of joining a meeting through using a presence status indicator of a contact begins at step 205 in which a user identifies a contact, i.e., a contact included in a contact list that is displayed on a screen of a system used by the user, with a presence status that indicates that the contact is currently in attendance at a meeting. After the user identifies the contact, the user clicks on the presence status indicator of the contact in step 209 to initiate a process of joining the meeting.

Once the user clicks on the presence status indicator of the contact, the user is provided with information that specifies parameters associated with the meeting in step 213. In one embodiment, when the user clicks on the presence status indicator of the contact, a dialog box or window opens and the information is displayed in the dialog box or the window. The parameters associated with the meeting may include, but are not limited to including, a meeting identifier, a location of the meeting, a starting time of the meeting, an ending time of the meeting, a name of a host of the meeting, an indication of whether the meeting is a public meeting, and/or any password needed for joining the meeting. It should be understood that the parameters provided to the user may vary depending upon the identity of the user. For example, if the user is a group leader who is authorized to join all meetings involving his or her group by default, then the user may be provided with a password to join a private meeting. On the other hand, if the user is a low level member of a group, then the user may not be provided with a password to join a private meeting.

In step 217, the user attempts to join the meeting. The user may attempt to join the meeting, for example, by selecting options through a dialog box or window displayed on a screen of a system of the user. It should be appreciated that if the user makes entries or selections through the dialog box, authorization from the contact or a meeting host may be solicited as a result. Typically, when the user attempts to join the meeting, the user may contact a meeting or conference server.

A determination is made in step 221 as to whether the user has successfully joined the meeting. If it is determined in step 221 that the user has not successfully joined the meeting, the process of joining a meeting through using a presence status indicator of a contact is completed.

Alternatively, if it is determined in step 221 that the user has successfully joined the meeting, the user may participate in the meeting at step 225. Then, in step 229, the meeting is added to a calendar of the user such that an appropriate block of time is shown as being busy due to participation in the meeting. When the meeting is added to the calendar, at least some parameters associated with the meeting may also be added to the calendar.

After the meeting is added to the calendar of the user, a presence status of the user is updated to indicate current attendance at the meeting in step 233. In other words, a presence status indicator of the user is updated to indicate that the user is in the meeting. Upon the presence status of the user being updated, the process of joining a meeting through using a presence status indicator of a contact is completed.

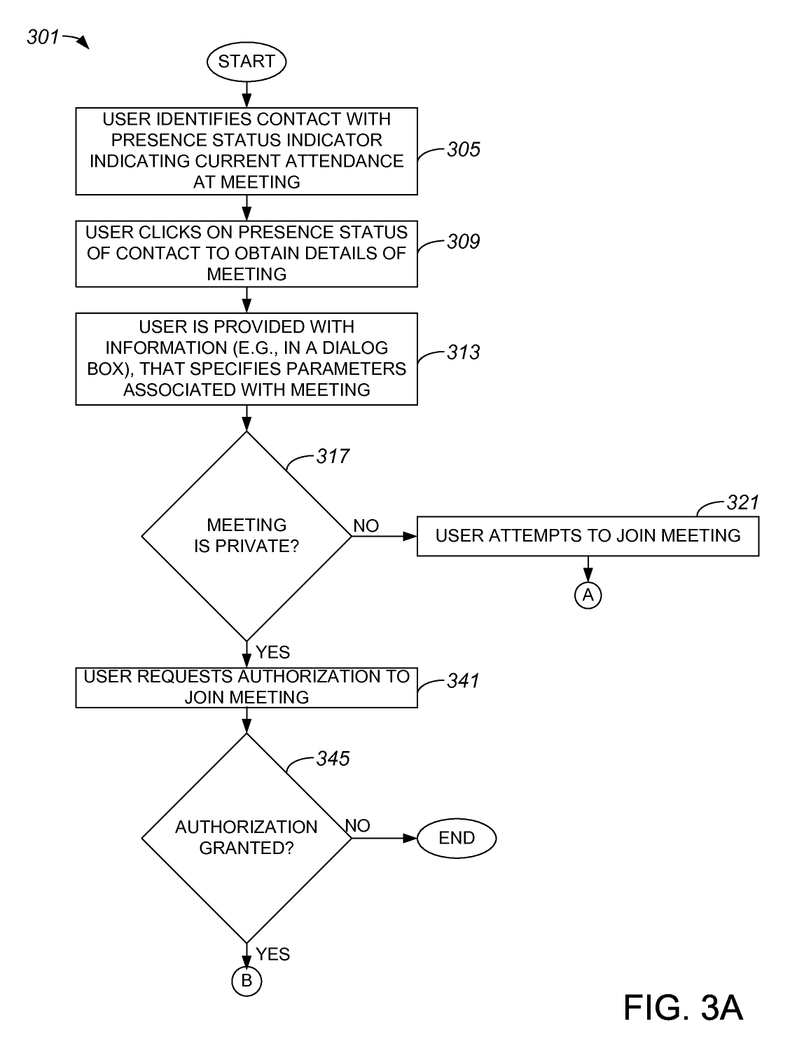

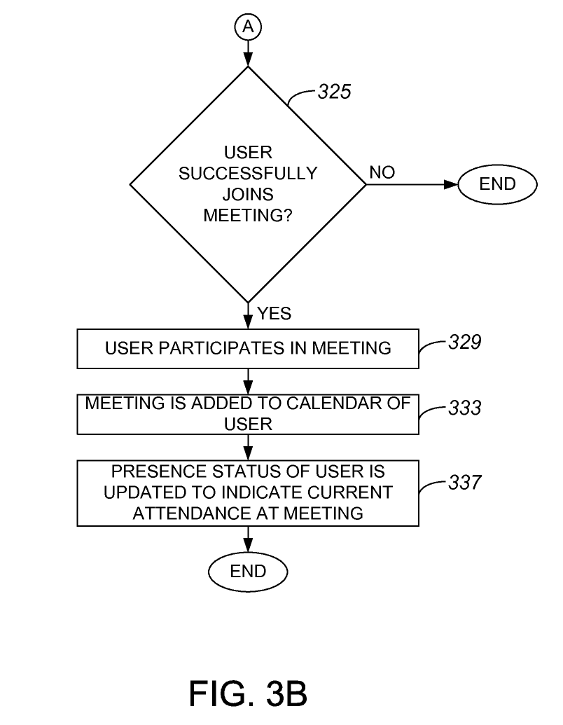

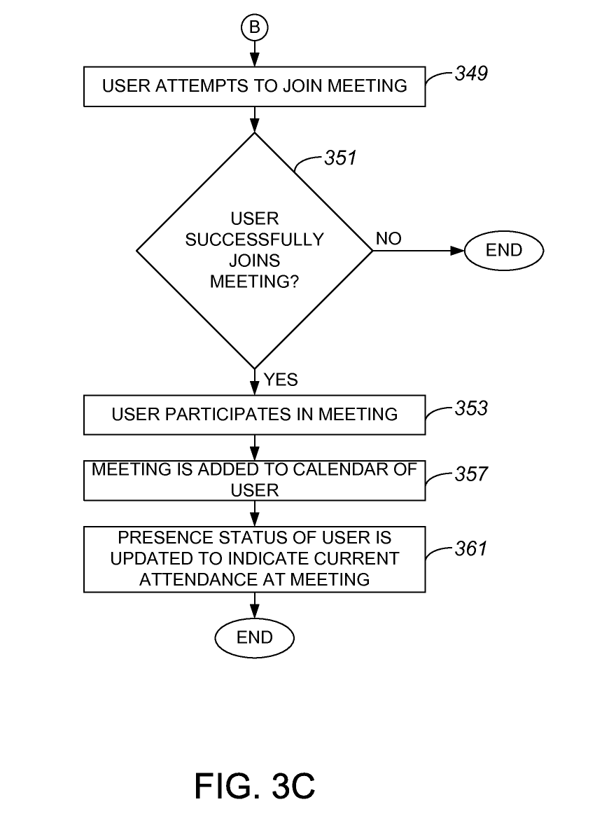

When a user attempts to join a meeting, an authorization process may be needed to determine if the user has permission, or if the user may obtain permission, to join the meeting. With reference to FIGS. 3A-C, a method of joining a meeting through using a presence status indicator of a contact in a contact list that involves authorizing the user will be described in accordance with an embodiment. A process 301 of joining a meeting through using a presence status indicator of a contact begins at step 305 in which a user identifies a contact, i.e., a contact included in a contact list that is displayed on a screen of a system used by the user, with a presence status that indicates that the contact is currently in attendance at a meeting. After the user identifies the contact, the user clicks on the presence status indicator of the contact in step 309 to obtain details of the meeting.

After the user clicks on the presence status indicator of the contact, the user is provided with information that specifies parameters associated with the meeting in step 313. In one embodiment, when the user clicks on the presence status indicator of the contact, a dialog box or window opens and the information is displayed in the dialog box or the window.

A determination is made in step 317 as to whether the meeting is a private meeting. It should be appreciated that a public meeting may generally be substantially automatically joined by anyone, while a private meeting may have an associated password or may otherwise involve an authentication process. If it is determined that the meeting is not a private meeting, the indication is that the meeting is a public meeting. As such, process flow moves to step 321 in which the user attempts to join the meeting. The user may attempt to join the meeting, for example, by selecting options through a dialog box or window displayed on a screen of a system of the user. It should be appreciated that if the user makes entries or selections through the dialog box, authorization from the contact or a meeting host may be solicited as a result.

From step 321, process flow proceeds to step 325 in which it is determined whether the user has successfully joined the meeting. If it is determined that the user has not successfully joined the meeting, the process of joining a meeting through using a presence status indicator of a contact is completed.

Alternatively, if it is determined in step 325 that the user successfully joins the meeting, the user may participate in the meeting at step 329. Then, in step 333, the meeting is added to a calendar of the user such that an appropriate block of time is shown as being busy due to participation in the meeting. When the meeting is added to the calendar, at least some parameters associated with the meeting may also be added to the calendar. After the meeting is added to the calendar of the user, a presence status indicator of the user is updated to indicate current attendance at the meeting in step 337, and the process of joining a meeting through using a presence status indicator of a contact is completed.

Returning to step 317 and the determination of whether the meeting is a private meeting, if it is determined that the meeting is private, the implication is that at least some authorization is needed to provide the user with the ability to join the meeting. When the meeting is determined to be private, process flow moves from step 317 to step 341 in which the user effectively requests authorization to join the meeting. Requesting authorization to join the meeting may include requesting, e.g., through a dialog box displayed to the user, that the contact or host of the meeting provide authorization, e.g., in the form of a password. It should be appreciated, however, that authorization may be provided or granted without the use of a password.

It is determined in step 345 whether authorization has been granted. If the determination is that authorization has not been granted, then the process of joining a meeting through using a presence status indicator of a contact is completed. Alternatively, if the determination is that authorization has been granted, process flow moves to step 349 in which the user attempts to join the meeting. The user may attempt to join the meeting, for example, by selecting options through a dialog box or window displayed on a screen of a system of the user. In one embodiment, the user may enter a password associated with the meeting using an interface provided by a dialog box.

In step 351, a determination is made as to whether the user has successfully joined the meeting. If it is determined that the user has not successfully joined the meeting, the process of joining a meeting through using a presence status indicator of a contact is completed. Alternatively, if it is determined in step 351 that the user successfully joins the meeting, the user may participate in the meeting at step 353. The meeting, as well as parameters associated with the meeting, may then be added in step 357 to a calendar of the user such that an appropriate block of time is shown as being busy due to participation in the meeting. After the meeting is added to the calendar of the user, a presence status indicator of the user is updated to indicate current attendance at the meeting in step 361, and the process of joining a meeting through using a presence status indicator of a contact is completed.

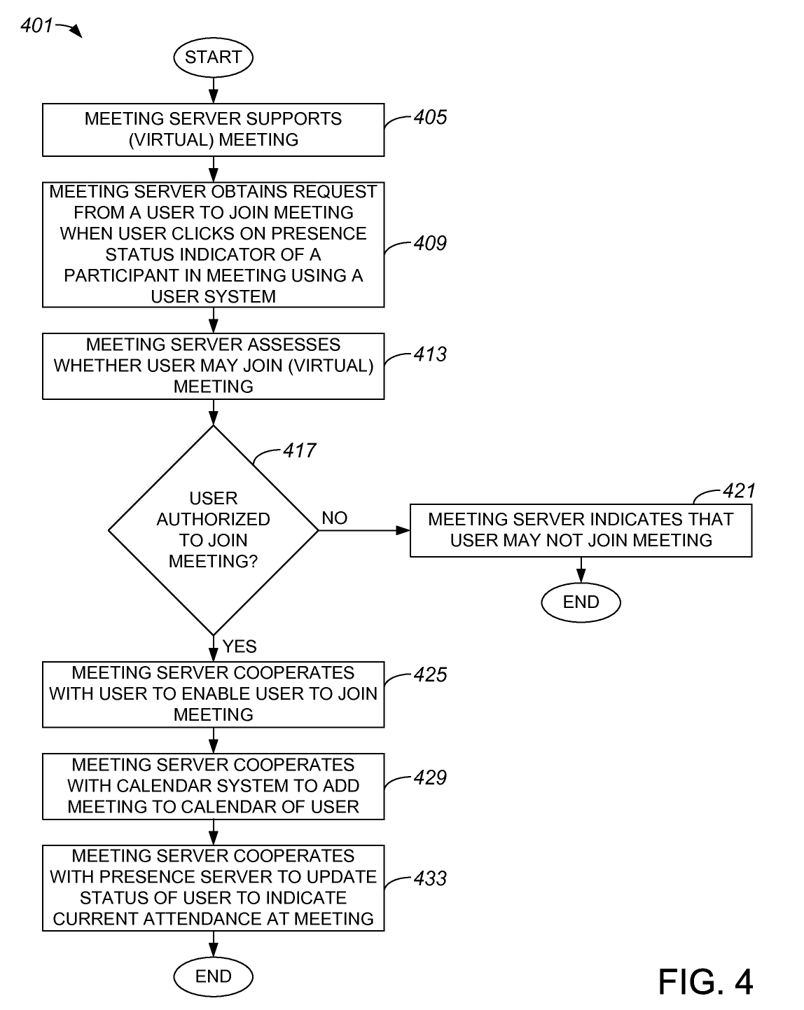

FIG. 4 is a process flow diagram which illustrates a method of allowing a user to join a meeting through using a presence status indicator of a contact in a contact list, from the point of view of a meeting server, in accordance with an embodiment. A process 401 of allowing a user to join a meeting through using a presence status indicator of a contact begins at step 405 in which a meeting server or a conference server supports a meeting, e.g., a virtual meeting. Supporting a meeting typically includes allowing parties, including a contact of a user in the described embodiment, to interact.

In step 409, the meeting server obtains a request from a user to join a meeting, e.g., an ongoing meeting. The request from the user is obtained when the user clicks on or, more generally, activates a presence status indicator of a contact that is identified as being a participant in the meeting. As previously mentioned, the presence status indicator of the contact may be displayed as a part of a contact list on a display screen of a system operated by the user.

Once the meeting server obtains the request from the user to join a meeting, the meeting server assesses whether the user may join the meeting in step 413. Such an assessment may generally include authenticating the user, or otherwise determining whether the user may be granted permission to join the meeting. Authenticating the user may include, for example, informing the contact that the user would like to join the meeting and soliciting a response from the contact, identifying an owner of the meeting and soliciting a response from the owner, and/or consulting a list of authorizations associated with the meeting to determine if the user is effectively identified as being authorized. It should be appreciated, however, that if the meeting is a public meeting, the user may substantially automatically be deemed as having permission to join the meeting.

In step 417, it is determined whether the user is authorized to join the meeting. If it is determined that the user is not authorized to join the meeting, then in step 421, the meeting server indicates that the user may not join the meeting, and the process of allowing a user to join a meeting is completed. In one embodiment, the meeting server may display a dialog box or a window on a system of the user that indicates that the user has not been authorized to join the meeting.

Alternatively, if it is determined in step 417 that the user is authorized to join the meeting, then process flow proceeds to step 425 in which the meeting server cooperates with the user to enable the user to join the meeting. Cooperation between the meeting server and the user may include, but is not limited to including, the user selecting a “join meeting” option from a menu and/or the meeting server soliciting the user for a meeting password. After the user joins the meeting, the meeting server cooperates with a calendar system to add the meeting to a calendar of the user in step 419. Then, in step 433, the meeting server cooperates with a presence server to update a presence status of the user to indicate that the user is currently attending the meeting. Once the presence status of the user is updated, the process of allowing a user to join a meeting is completed.

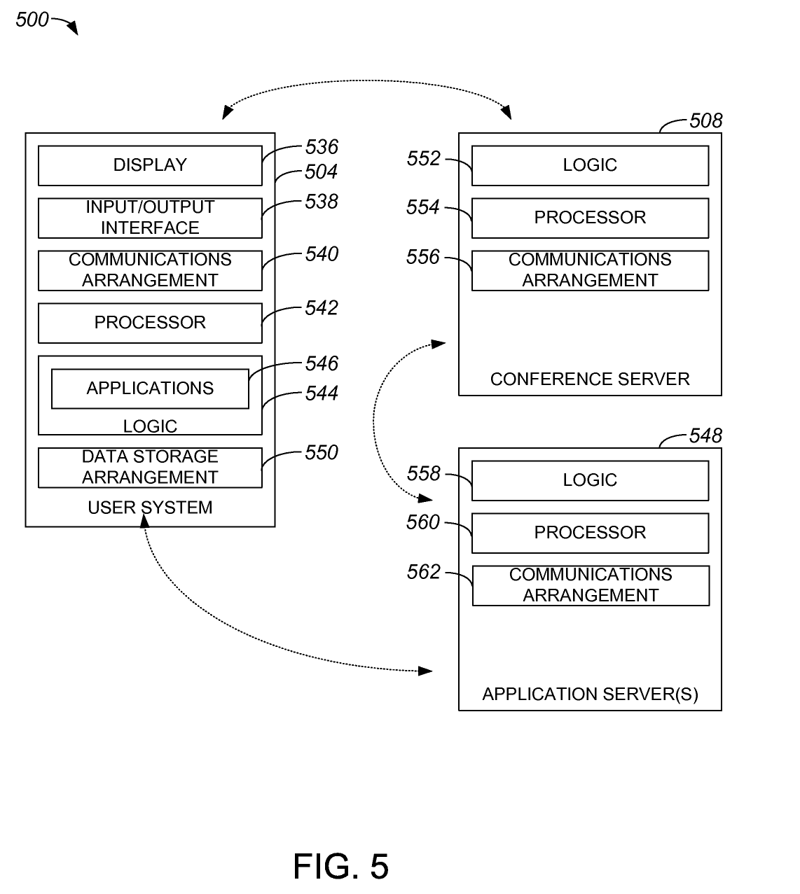

Referring next to FIG. 5, a user system, a conference server, and an application server of an overall system that supports a contact list in which a presence status indicator of a contact may be used to allow a user to join a meeting will be described in accordance with an embodiment. An overall system 500, which may be distributed with respect to a network, includes a user system 504, a conference server 508, and one or more application servers 548. It should be appreciated, however, that in lieu of being distributed, overall system 500 may instead be associated with a single device or apparatus.

User system 504 may generally be a computing system, or a device that includes computing capabilities. For example, user system 504 may be a personal computer, a tablet computing device, or a smart phone. User system 504 includes a display 536 that is generally a screen on which a contact list may be presented, an input/output interface 536 that allows a user to provide input into user system 504, e.g., input that enables a presence status indicator to be activated. A communications arrangement 540 generally includes input/output ports that allow user system 504 to engage in communications with conference server 508 and application server 548. A processor 542 is configured to execute logic 544 associated with applications 546, e.g., applications that support a contact list and participation in a meeting. In general, logic 544 may include hardware and/or software logic. A data storage arrangement 550 may store information related to a meeting in which a user of user system 504 is a participant.

Conference server 508, or a meeting server, is arranged to support real-time conferences that may effectively be attended by multiple parties. Conference server 508 may be a part of a unified enterprise or collaborative communications system. Conferencing functionality supported by conference server 508 may include, but is not limited to including, voice conferencing functionality, video conferencing functionality, web conferencing functionality, and data sharing functionality. Logic 552 generally includes software and/or hardware logic that supports the conferencing functionality, and a processor 554 is configured to execute logic 552 such that the conferencing functionality may be provided. A communications arrangement 556 generally includes input/output ports that allow conference server 508 to engage in communications with user system 504 and application server 548.

At least one application server 548 is typically included in overall system 500. Application server 548 may support a calendaring application and/or a presence sensing application, but is not limited to supporting a calendaring application and/or a presence sensing application. For example, application server 548 may cause a conference joined by a user using a presence status indicator to be added to a calendar of the user and/or may cause the presence status indicator of the user to be updated to indicate participation in the conference. In general, application server 548 includes logic 558, a processor 560 arranged to execute logic 558, and a communications arrangement 562. Logic 558 may include hardware and/or software logic that allows information associated with a conference, as obtained either directly from conference server 508 or indirectly from conference server 508 through user system 504, to be used to update an application, e.g., a calendaring application or a presence sensing application, associated with a user. A communications arrangement 562 generally includes input/output ports that allow application server 548 to engage in communications with user system 504 and conference server 508. It should be appreciated that although application server 548 is shown in FIG. 5 as being a substantially standalone server, the functionality associated with application server 548 may instead be included in user system 504, or distributed between application server 548 and user system 504.

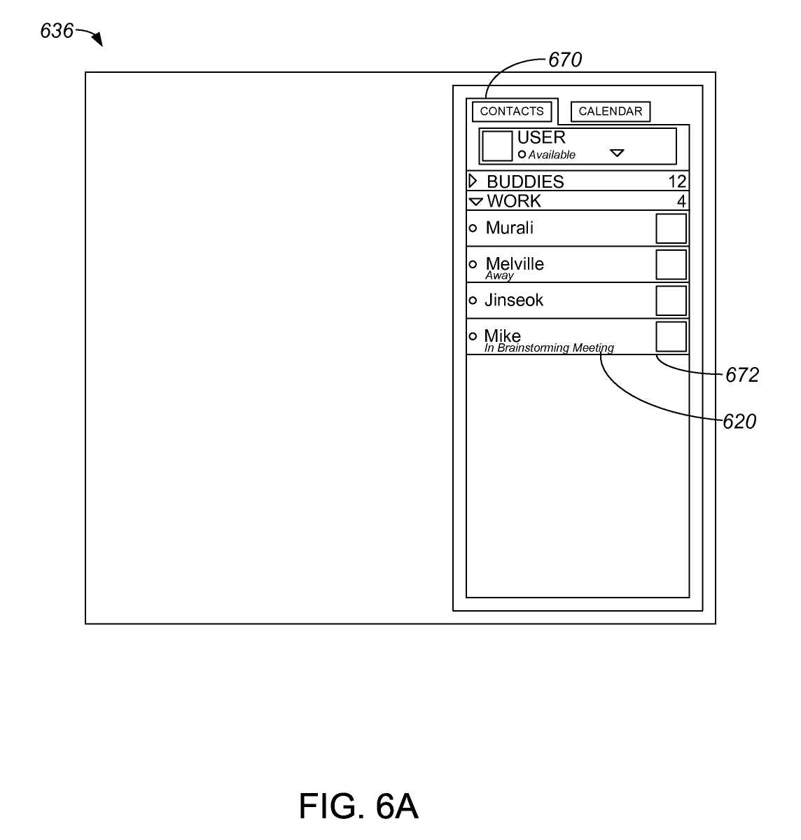

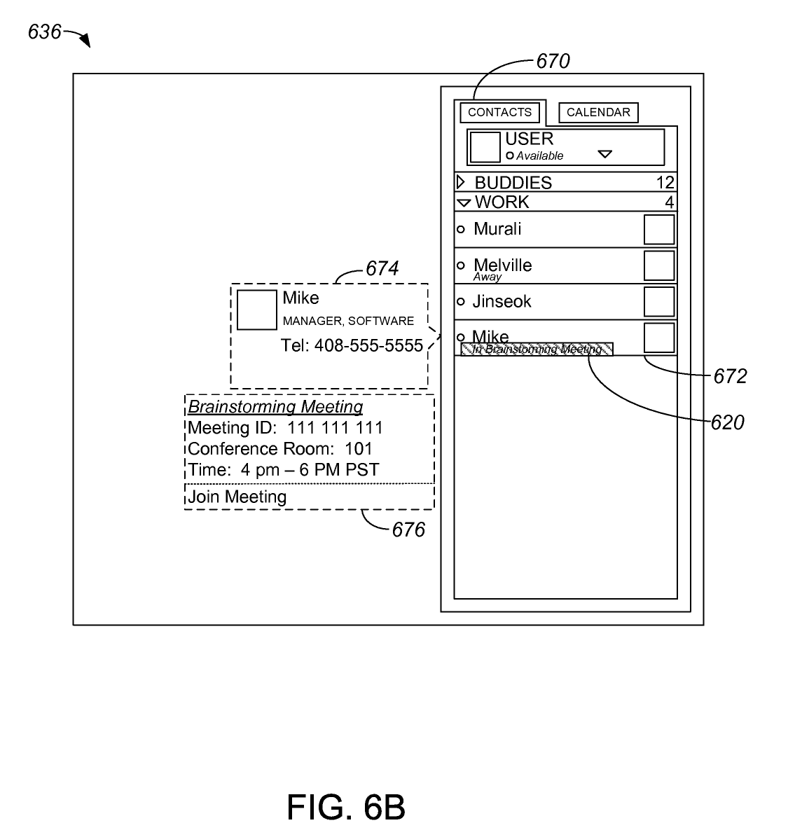

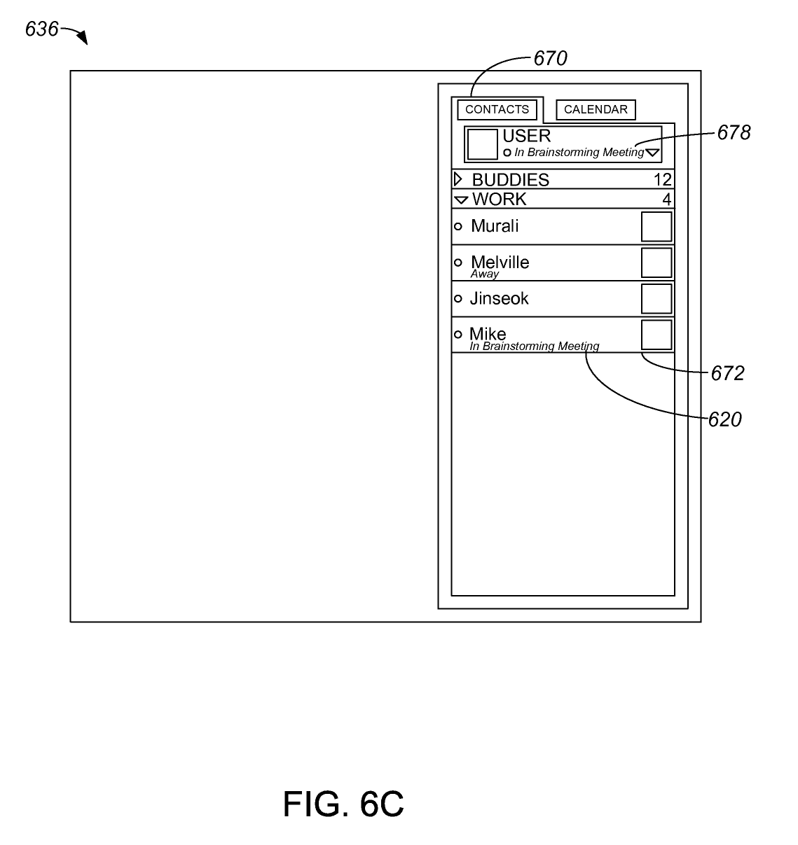

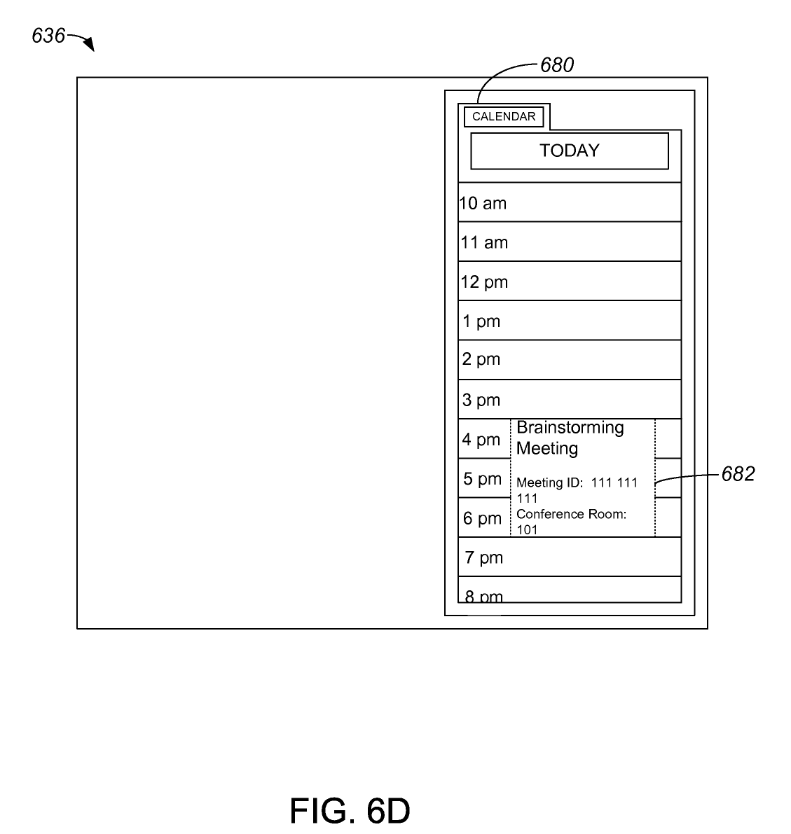

With reference to FIGS. 6A-D, a process of joining a meeting that is in progress using a current presence status of a contact will be described in accordance with an embodiment. FIG. 6A is a diagrammatic representation of a display, e.g., a display associated with a computing system, that exhibits a contact list which includes a contact with a presence status indicator that indicates that the contact is participating in a meeting at a time t1. A display 636 is arranged to display or to exhibit a contact list 670 that is a list of contacts of a user, or a party associated with display 636. Contact list 670 may be associated with a teleconferencing application or a collaborative communications application such as WebEx, available from Cisco Systems, Inc. It should be appreciated, however, that contact list 670 is not limited to being associated with a collaborative communications application and may be associated with any application in which a user may benefit from utilizing a contact list. Contact list 670 includes a contact 672 who, at a time t1, has a presence status indicator 620 that indicates participation in a “Brainstorming Meeting.”

When a user identifies that a contact 672 has presence status indicator 620 that indicates that contact 672 is participating in a meeting, i.e., “Brainstorming Meeting,” the user may determine that he or she would like to participate in the meeting. Accordingly, at a time t2, the user may effectively activate presence status indicator 620, as shown in FIG. 6B. Activating presence status indicator 620 may generally include, but is not limited to including, “mousing over” presence status indicator 620 and clicking on presence status indicator 620 using a computer input/output device. In general, activating presence status indicator 620 involves selecting presence status indicator 620 to cause an action to occur. The action may include, but is not limited to including, causing a dialog box 676 to open and be displayed on display 636, initiating a process of adding the user as a participant in a meeting, and/or allowing the user to join the meeting.

As shown in FIG. 6B, once presence status indicator 620 is activated, dialog box 676 opens and a box 674 that displays information relating to contact 672 opens at a time t2. Dialog box 676 displays information associated with the meeting in which contact 672 is participating. The displayed information may include the name of the meeting, a meeting identifier, a location of the meeting, a time of the meeting, and a duration of the meeting. Dialog box 676 may also include a link that enables a user to join the meeting.

When a user decides to join the meeting identified in presence status indicator 620, the user may activate the link provided in dialog box 676. In the described embodiment, the user successfully joins the meeting. FIG. 6C is a diagrammatic representation of display 636 at a time t3 after the user has joined the meeting using presence status indicator 620 in accordance with an embodiment. Upon joining the meeting identified in presence status indicator 620, a presence status indicator 678 of the user is updated to indicate that the user is participating in “Brainstorming Meeting.”

In one embodiment, in addition to updating presence status indicator 678 to indicate participation in a meeting, a calendar of the user may be updated to include information relating to the meeting. As shown in FIG. 6D, a calendar 680 of the user is updated at a time t4 to indicate that the user is participating in a meeting. An entry 682 associated with the meeting is added to calendar 680, and provides information relating to the meeting.

Although only a few embodiments have been described in this disclosure, it should be understood that the disclosure may be embodied in many other specific forms without departing from the spirit or the scope of the present disclosure. By way of example, joining a meeting using an interface associated with a current presence status indicator of a contact in a contact list has been described as enabling a user to join a meeting that is in progress. In addition to being able to join a meeting that is ongoing or currently in progress, a user may also use a current presence status indicator of a contact to effectively join a future meeting. That is, a user may use a current presence status indicator of a contact to substantially schedule himself or herself to attend a future meeting. For instance, of a current presence status indicator of a contact indicates “Currently Available—joining Brainstorming Meeting at 2 pm,” by clicking on or otherwise activating the current presence status indicator, a user may effectively schedule himself or herself to attend the Brainstorming Meeting, and the Brainstorming Meeting may be added as a calendar entry in a calendar of the user.

In one embodiment, rather than substantially automatically causing a user to join a meeting by clicking or otherwise selecting a presence status indicator of a contact, a user may instead be provided with information that would enable the user to join the meeting. For example, if the meeting is a future meeting, information that would enable the user to join the meeting in the future may be provided to the user. As mentioned above, the meeting may be added as a calendar entry in the calendar of the user. The calendar entry may include information such as a meeting name, a meeting identifier, a dial-in number, and/or a meeting location. Alternatively, for an on-going or current meeting, rather than causing a user to substantially automatically join a meeting, the user may instead be provided with dial-in information that allows the user to effectively manually join the meeting.

In general, information provided to a user upon the user clicking on, or otherwise effectively selecting, a presence status indicator of a contact in order to join a meeting my vary. As discussed above, e.g., with respect to FIG. 6B, information provided to a user in a dialog box may include the name of a meeting, a meeting identifier, a location of or venue for the meeting, and a time and/or duration of the meeting. Information provided to a user may include additional information, or different information, without departing from the spirit or the scope of the present disclosure. Additional information may include, but is not limited to including, dial-in information for the meeting, a list of participants in the meeting, and/or an indication of whether the meeting is a private meeting.

The information that may be provided to a user when the user clicks on or otherwise selects a presence status indicator of a contact may be substantially controlled by the contact. That is, an individual or entity may essentially control the information that is to be displayed when a presence status indicator of the individual is accessed. For example, preferences may be set such that no information relating to a meeting may be displayed when a presence status indicator is activated, or such that substantially only the name of a meeting is displayed. In one embodiment, preferences may be set such that different parties may see different information, e.g., preferences may be set such that a high level party in an organization may see more information relating to a meeting than a low level party in the organization.

A contact list may be a part of an overall application that supports meetings. By way of example, a unified enterprise or collaborative communications application that supports virtual meetings may also include a contact list. It should be appreciated, however, that a contact list may instead be a substantially separate application from an application that support virtual meetings, but may be arranged to cooperate with the application that supports virtual meetings to enable a user to join a meeting using a presence status indicator associated with the contact list.

While a user is in the process of joining a meeting, a presence status indicator of the user may indicate that the user is in the process of joining the meeting. By indicating the a user is in the process of joining a particular meeting, a host of the particular meeting who lists the user as a contact may identify that the user is attempting to join the particular meeting, and may take steps to facilitate allowing the user to join the particular meeting. For example, the host of the meeting may identify that the user is attempting to join the meeting and may issue an invitation to the meeting.

As described above, when a user joins a meeting using a presence status indicator of a contact in a contact list, the meeting may be added to a calendar of the user. It should be appreciated that the calendar may either be a part of the same application that supports the contact list and the meeting, or the calendar may be part of a separate calendar application. In general, a meeting may be added to any calendar associated with the user.

A presence status indicator may generally be activated using any suitable method. As mentioned above, a user may click on or otherwise select a presence status indicator using an input/output device to substantially activate the presence status indicator. In one embodiment, when a display on which a contact list is exhibited is a touch screen, a presence status indicator may be activated when a user touches the display over the location at which the presence status indicator is displayed. It should be appreciated, however, a presence status indicator is not limited to being activated by clicking on the presence status indicator.

The embodiments may be implemented as hardware and/or software logic embodied in a tangible medium that, when executed, is operable to perform the various methods and processes described above. That is, the logic may be embodied as physical arrangements or components. A tangible medium may be substantially any computer-readable medium that is capable of storing logic which may be executed, e.g., by a computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
accessing a contact list, the contact list being arranged to display a contact associated with a user, wherein the contact is displayed on a display screen;
identifying the contact, the contact having an associated first presence status indicator, the first presence status indicator being arranged to indicate a participation of the contact in a meeting, the first presence status indicator being presented on the display screen; and
activating the first presence status indicator, wherein activating the first presence status indicator causes information arranged to enable a user to join the meeting to be presented on the display screen.

2. The method of claim 1 wherein activating the first presence status indicator further causes the user to automatically join the meeting.

3. The method of claim 2 wherein activating the first presence status indicator causes an interface that allows the user to join the meeting to be displayed on the display screen, and wherein when the user activates the interface, the user is joined in the meeting.

4. The method of claim 2 wherein after the user joins the meeting, a second presence status indicator of the user is updated to indicate a participation of the user in the meeting.

5. The method of claim 1 further including:
joining the meeting, wherein joining the meeting allows the user to participate in the meeting.

6. The method of claim 5 wherein joining the meeting includes authenticating the user with respect to the meeting.

7. The method of claim 1 wherein the meeting is a virtual meeting, and the contact list and the meeting are supported by one selected from a group including a unified enterprise application, a teleconferencing application, and a collaborative communications application.

8. The method of claim 1 wherein activating the first presence status indicator includes clicking on the first presence status indicator using an input/output device that is in communication with the display.

9. A tangible, non-transitory computer-readable medium comprising computer program code, the computer program code, when executed, configured to:
access a contact list, the contact list being arranged to display a contact associated with a user, wherein the contact is displayed on a display screen;
identify the contact, the contact having an associated first presence status indicator, the first presence status indicator being arranged to indicate a participation of the contact in a meeting, the first presence status indicator being presented on the display screen; and
activate the first presence status indicator, wherein the computer program code configured to activate the first presence status indicator is further configured to cause information arranged to enable a user to join the meeting to be presented on the display screen.

10. The tangible, non-transitory computer-readable medium of claim 9 wherein the computer program code configured to activate the first presence status indicator is further configured to cause the user to automatically join the meeting.

11. The tangible, non-transitory computer-readable medium of claim 10 wherein the computer program code configured to activate the first presence status indicator is further configured to display an interface on the display screen that allows the user to join the meeting, wherein when the user activates the interface, the user is joined in the meeting.

12. The tangible, non-transitory computer-readable medium of claim 10 wherein after the user joins the meeting, a second presence status indicator of the user is updated to indicate a participation of the user in the meeting.

13. The tangible, non-transitory computer-readable medium of claim 9 wherein the computer program code is further configured to:
join the meeting, wherein the computer program code configured to join the meeting allows the user to participate in the meeting.

14. The tangible, non-transitory computer-readable medium of claim 13 wherein the computer program code configured to join the meeting is further configured to authenticate the user with respect to the meeting.

15. The tangible, non-transitory computer-readable medium of claim 9 wherein the meeting is a virtual meeting, and the contact list and the meeting are supported by one selected from a group including a unified enterprise application, a teleconferencing application, and a collaborative communications application.

16. The tangible, non-transitory computer-readable medium of claim 10 wherein the computer program code configured to activate the first presence status indicator is further configured to enable an input/output device that is in communication with the display to be used to activate the first presence status indicator.

17. An apparatus comprising:
means for accessing a contact list, the contact list being arranged to display a contact associated with a user, wherein the contact is displayed on a display screen;
means for identifying the contact, the contact having an associated first presence status indicator, the first presence status indicator being arranged to indicate a participation of the contact in a meeting, the first presence status indicator being presented on the display screen; and
means for activating the first presence status indicator, wherein the means for activating the first presence status indicator are configured to cause information arranged to enable a user to join the meeting to be presented on the display screen.

18. An apparatus comprising:
at least one application, the at least one application being arranged to support a contact list and a meeting;
a processor, the processor being arranged to execute code associated with the at least one application;
a display, the display being arranged to display the contact list, the contact list including a first contact having an associated first presence status indicator, the first presence status indicator being arranged to indicate that the first contact is a participant in the meeting; and
an interface, the interface being arranged to enable the first presence status indicator to be activated, wherein the at least one application is arranged to cause information associated with the meeting to be displayed on the display when the first presence status indicator is activated.

19. The apparatus of claim 18 wherein when the first presence status indicator is activated, the at least one application further initiates joining a user in the meeting.

20. The apparatus of claim 18 wherein when the first presence status indicator is activated, the at least one application further joins a user in the meeting and updates a second presence status indicator of the user to indicate that the user is a participant in the meeting.

21. The apparatus of claim 20 wherein the at least one application is further arranged to support a calendar of the user, wherein when the first presence status indicator is activated, the at least one application further adds an entry associated with the meeting to the calendar of the user.
